(19) United States
(12) Patent Application Publication
(10) Pub. No.: US 2002/0133601 A1
(43) Pub. Date: Sep. 19, 2002

(54) Failover of servers over which data is partitioned

(76) Inventors: Walter J. Kennamer, Issaquah, WA (US); Christopher L. Weider, Everett, WA (US); Brian E. Tschumper, Kenmore, WA (US)

Correspondence Address: STEVEN J. ROCCI, WOODCOCK WASHBURN KURTZ, MACKIEWICZ & NORRIS LLP, ONE LIBERTY PLACE-46TH FLOOR, PHILADELPHIA, PA, 19103, US

(21) Appl. No.: 09/681,309

(22) Filed: Mar. 16, 2001

(51) Int. Cl. G06F 15/16; G06F 15/173

(52) U.S. Cl. 709/229; 709/223

(57) ABSTRACT

Failover of servers over which data is partitioned is disclosed. A first server services client requests for data of a first type, a second server services client requests for data of a second type, and so on. A master server manages notifications from clients and servers as to indication that one of the servers is offline. When the master server receives such a notification, it verifies that the indicated server is in fact offline. If the server is offline, then the master server so notifies the other server. When the first server is offline, one of the other servers may become the failover server, processing client requests for data usually processed by the first server.

### BACKGROUND OF INVENTION

This invention relates generally to servers over which data is partitioned, and more particularly to failover of such servers.

Industrial-strength web serving has become a priority as web browsing has increased in popularity. Web serving involves storing data on a number of web servers. When a web browser requests the data from the web servers over the Internet, one or more of the web servers returns the requested data. This data is then usually shown within the web browser, for the viewing by the user operating the web browser.

Invariably, web servers fail for any number of reasons. To ensure that users can still access the data stored on the web servers, there are usually backup or failover provisions. For example, in one common approach, the data is replicated across a number of different web servers. When one of the web servers fails, any of the other web servers can field the requests for the data. Unless a large number of the web servers go down, the failover is generally imperceptible from the user's standpoint.

Replication, however, is not a useful failover strategy for situations where the data is changing constantly. For example, where user preference and other user-specific information are stored on a web server, at any one time hundreds of users may be changing their respective data. In such situations, replication of the data across even tens of web servers results in adverse performance of the web servers. Each time data is changed on one web server, the other web servers must be notified so that they, too, can make the same data change.

For constantly changing data, the data is more typically partitioned across a number of different web servers. Each web server, in other words, only handles a percentage of all the data. This is more efficient from a performance standpoint, but if any one of the web servers fails, the data uniquely stored on that server is unavailable until the server comes back online. This is untenable for reliable web serving, however. For this and other reasons, therefore, there is a need for the present invention.

### SUMMARY OF INVENTION

The invention relates to server failover where data is partitioned among a number of servers. The servers are generally described as data servers, because they store data. The servers may be web servers, or other types of servers. In a two data server scenario, data of a first type is stored on a first server, and data of a second type is stored on a second server. It is said that the data of both types is partitioned over the first and the second servers. The first server services client requests for data of the first type, whereas the second server services client requests for data of the second type. Preferably, each server only caches its respective data, such that all the data is permanently stored on a database that is otherwise optional. It is noted that the invention is applicable to scenarios in which there are more than two data servers as well.

An optional master server manages notifications from clients and from the servers as to indication that one of the servers is offline. As used herein, offline means that the server is inaccessible. This may be because the server has failed, or it may be because the connection between the server and the clients and/or the other server(s) have failed. That is, offline is a general term meant to encompass any of these situations, as well as other situations that prevent a server from processing client requests. When the master server receives such a notification, it verifies that the indicated server is in fact offline. If the server is offline, then the master server so notifies the other server in a two data server scenario. Similarly, a server coming back online can mean that the server has been restored from a state of failure, the connection between the server and a client or another server has been restored from a state of failure, or the server otherwise becomes accessible.

When a server is offline, the other server in a two data server scenario handles its client requests. For example, when the first server is offline, the second server becomes the failover server, processing client requests for data usually cached by the first server. Likewise, when the second server is offline, the first server becomes the failover server, processing client requests for data usually cached by the second server. The failover server obtains the requested data from the database, temporarily caches the data, and returns the data to the requestor client. When the offline server is back online, and the failover server is notified of this, preferably the failover server then deletes the data it temporarily has cached.

Thus, when a client desires to receive data, it determines which server it should request that data from, and submits the request to this server. If the server is online, then the request is processed, and the client receives the desired data. If the server is offline, the server will not answer the client's request. The client, optionally after a number of attempts, ultimately enters a failover mode, in which it selects a failover server to which to send the request. In the case of two servers, each server is the failover server for the other server. The client also notifies the optional master server when it is unable to contact a server.

Preferably, when a server receives a client request, it first determines whether the request is for data of the type normally processed by the server. If it is, the server processes the request, returning the requested data back to the requestor client. If the data is not normally of the type processed by the server, the server determines whether the correct server to handle data of the type requested has been marked offline in response to a notification by the master server. If the correct server has not been marked offline, the server attempts to contact the correct server itself. If successful, the server passes the request to the correct server, which processes the request. If unsuccessful, then the server processes the request itself, querying the database for the requested data where necessary.

The master server fields notifications as to servers potentially being down, from servers or clients. If it verifies a server being offline, it notifies the other servers. The master server preferably periodically checks whether the server is back online. If it determines that a server previously marked as offline is back online, the master server notifies the other servers that this server is back online.

A client preferably operates in failover mode as to an offline server for a predetermined length of time. During the failover mode, the client sends requests for data usually handled by the offline server to the failover server that it selected for the offline server. Once the predetermined length of time has expired, the client sends its next request for data of the type usually handled by the offline server to this server, to determine if it is back online. If the server is back online, then the failover mode is exited as to this server. If the server is still offline, the client stays in the failover mode for this server for at least another predetermined length of time.

In addition to those described in this summary, other aspects, advantages, and embodiments of the invention will become apparent by reading the detailed description, and referencing the drawings.

### BRIEF DESCRIPTION OF DRAWINGS

FIG. 1 is a diagram showing the basic system topology of the invention.

FIG. 2 is a diagram showing the topology of FIG. 1 in more detail.

FIGS. 3A and 3B depict a flowchart of a method performed by a client for sending a request.

FIG. 4 is a flowchart of a method performed by a client to determine a failover server for a data server that is not answering the client's request.

FIG. 5 is a flowchart of a method performed by a data server when receiving a client request.

FIG. 6 is a flowchart of a method performed by a data server to process a client request.

FIG. 7 is a flowchart of a method performed by a data server when it receives a notification from a master server that another data server is either online or offline.

FIG. 8 is a flowchart of a method performed by a master server when it receives a notification that a data server is potentially offline.

FIG. 9 is a flowchart of a method performed by a master server to periodically check whether an offline data server is back online.

FIG. 10 is a diagram showing normal operation between a client and a data server that is online.

FIG. 11 is a diagram showing the operation between a client and a data server that is acting as the failover server for another data server that is offline due to the server being down, or otherwise having failed.

FIG. 12 is a diagram showing the operation between a client and a data server that is acting as the failover server for another data server that is offline due to the connection between the server and the client being down, or otherwise having failed.

FIG. 13 is a diagram of a computerized device that can function as a client or as a server in the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, and other changes may be made without departing from the spirit or scope of the present invention. The following detailed description is, therefore, not to be taken in a limiting sense, and the scope of the present invention is defined only by the appended claims.

### System Topology

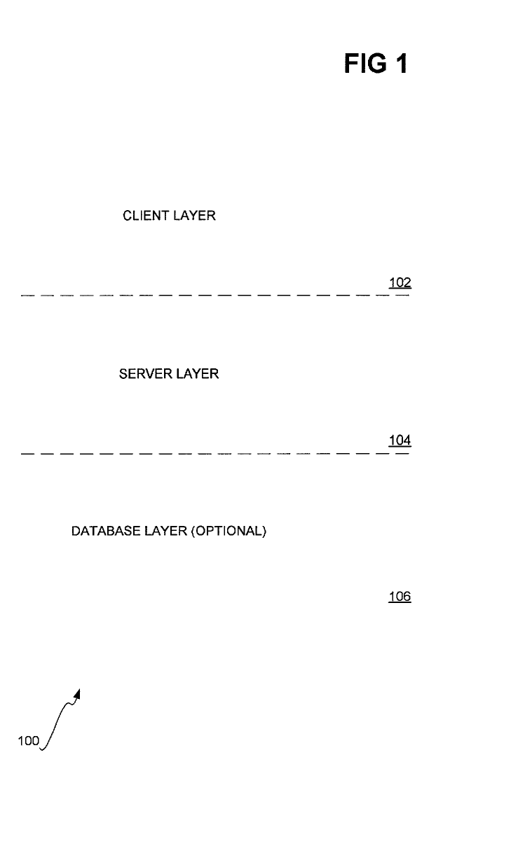

FIG. 1 is a diagram showing the overall topology 100 of the invention. There is a client layer 102, a server layer 104, and an optional database layer 106. The client layer 102 sends requests for data to the server layer 104. The client layer 102 can be populated with various types of clients. As used herein, the term client encompasses clients other than end-user clients. For example, a client may itself be a server, such as a web server, that fields requests from end-user clients over the Internet, and then forwards them to the server layer 104.

The data that is requested by the client layer 102 is partitioned over the server layer 104. The server layer 104 is populated with various types of data servers, such as web servers, and other types of servers. A client in the client layer 102, therefore, determines the server within the server layer 104 that handles requests for a particular type of data, and sends such requests to this server. The server layer 104 provides for failover when any of its servers are offline. Thus, the data is partitioned over the servers within the server layer 104 such that a first server is responsible for data of a first type, a second server is responsible for data of a second type, and so on.

The database layer 106 is optional. Where the database layer 106 is present, one or more databases within the layer 106 permanently store the data that is requested by the client layer 102. In such a scenario, the data servers within the server layer 104 cache the data permanently stored within the database layer 106. The data is partitioned for caching over the servers within the server layer 104, whereas the database layer 106 stores all such data. Preferably, the servers within the server layer 104 have sufficient memory and storage that they can cache at least a substantial portion of the data that they are responsible for caching. This means that the servers within the server layer 104 only rarely have to resort to the database layer 106 to obtain the data requested by clients in the client layer 102.

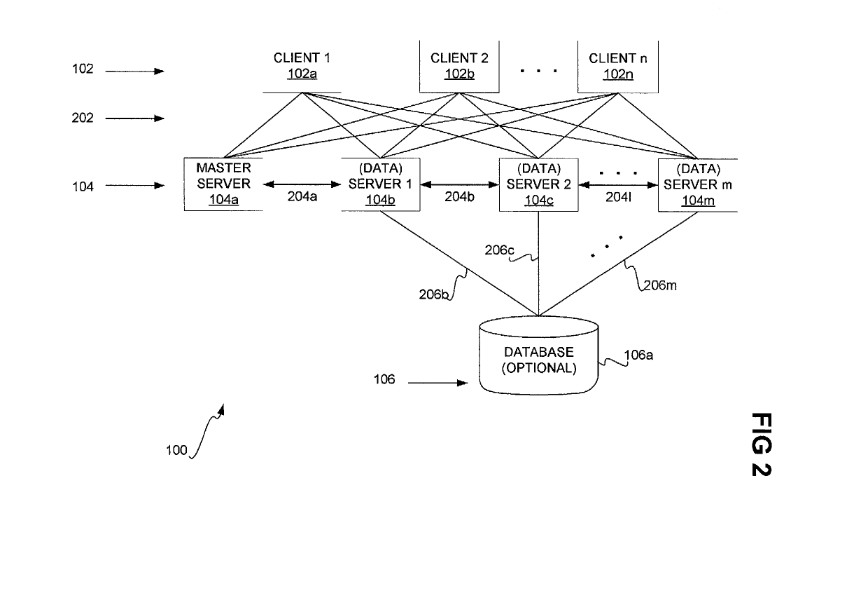

FIG. 2 is a diagram showing the topology 100 of FIG. 1 in more detail. The client layer 102 has a number of clients 102a, 102b, . . . , 102n. The server layer 104 includes a number of data servers 104b, 104c, . . . , 104m, as well as a master server 104a. The optional database layer 106 has at least one database 106a. Each of the clients within the client layer 102 is communicatively connected to each of the servers within the server layer 104, as indicated by the connection mesh 202. In turn, each of the data severs 104b, 104c, . . . , 104m within the server layer 104 is connected to each database within the database layer 106, such as the database 106a. This is shown by the connections 206b, 206c, . . . , 206m between the database 106a and the data servers 104b, 104c, . . . , 104m, respectively. The connections 204a, 204b, . . . , 204l indicate that the data servers 104a, 104b, . . . , 104m are able to communicate with one another. The master server 104a is also able to communicate with each of the data servers 104a, 104b, . . . , 104m, which is not expressly indicated in FIG. 2. It is noted that n and m as indicated in FIG. 2 can be any number, and n is not necessarily greater than m.

When a particular client wishes to request data from the server layer 104, it first determines which of the data servers 104b, 104c, . . . , 104m is responsible for the data. Alternatively, the client can request that the master server 104a indicate which of the data servers 104b, 104c, . . . , 104m, is responsible for the data. This is because the data is cached over the data servers. The client then sends its request to this server. Assuming that this server is online, the server processes the request. If the desired data is already cached or otherwise stored on the server, the server returns the data to the client. Otherwise, the server queries the database 106a for the data, temporarily caches the data, and returns the data to the client.

If a client within the client layer 102 cannot successfully send a request to the proper data server within the server layer 104, it optionally retries sending the request for a predetermined number of times. If the client is still unsuccessful, it notifies the master server 104a. The master server 104a then verifies that the data server has failed. If the data server is indeed offline, the master server 104a notifies the data servers 104b, 104c, . . . , 104m. The client determines a failover server to send the request to, and sends the request to the failover server. The failover server is one of the data servers 104b, 104c, . . . , 104m other than the data server that is offline.

When the failover server receives a client request, it verifies that it is the proper server to be processing the request. For example, the server verifies that the request is for data that is partitioned to that server. If it is not, this means that the server has been contacted as a failover server by the client. The failover server checks whether it has been notified by the master server 104a as to the proper server for the type of client request received being offline. If it has been so notified, the failover server processes the request, by, for example, requesting the data from the database 106a, temporarily caching it, and returning the data to the requester client.

If the failover server has not been notified by the master server 104a as to the proper server being offline, it sends the request to the proper data server. If the proper server has in fact failed, the failover server will not successfully be able to send the request to the proper server. In this case, it notifies the master server 104a, which performs verification as has been described. The failover server then processes the request for the proper server as has been described. If the proper server does successfully receive the request, then the proper server processes the request. The failover server may return the data to the client for the proper server, if the proper server cannot itself communicate with the requester client.

When a client has resorted to sending a request for a type of data to a failover server, instead of to the server that usually handles that type of data, the client is said to have entered failover mode as to that data server. Failover mode continues for a predetermined length of time, such that requests are sent to the determined failover server, instead of to the proper server. Once this time has expired, the client again tries to send the request to the proper data server. If successful, then the client exits failover mode as to that server. If unsuccessful, the client stays in failover mode for that server for at least another predetermined length of time.

The master server 104a, when it has verified that a given data server is offline, periodically checks whether the data server is back online. If the data server is back online, the master server 104a notifies the other data servers within the server layer 104 that the previously offline server is now back online. The data servers, when receiving such a notification, then mark the indicated server as back online.

### Client Perspective

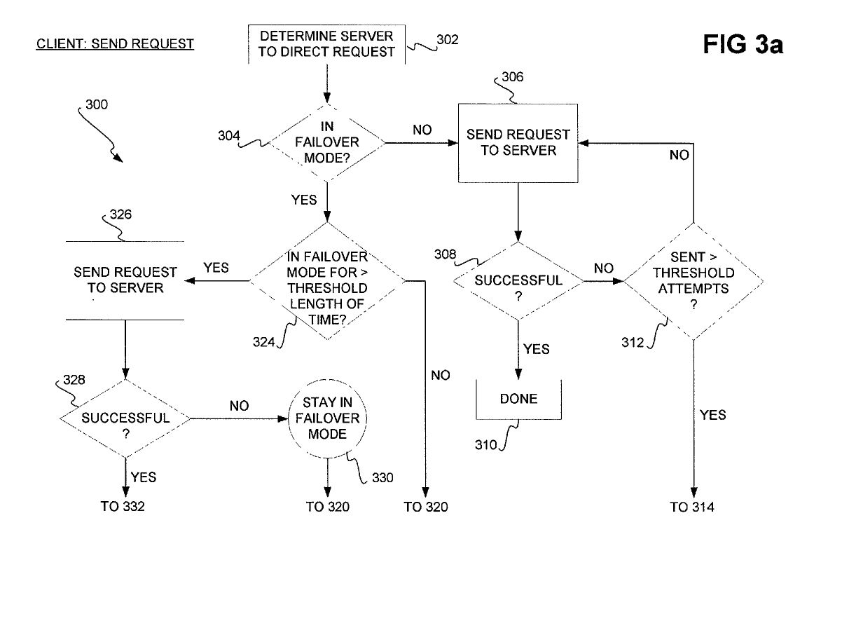

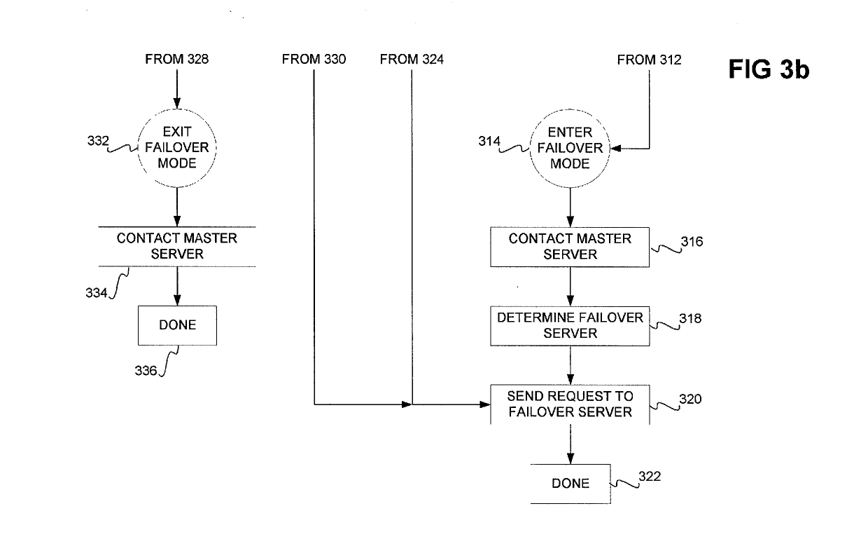

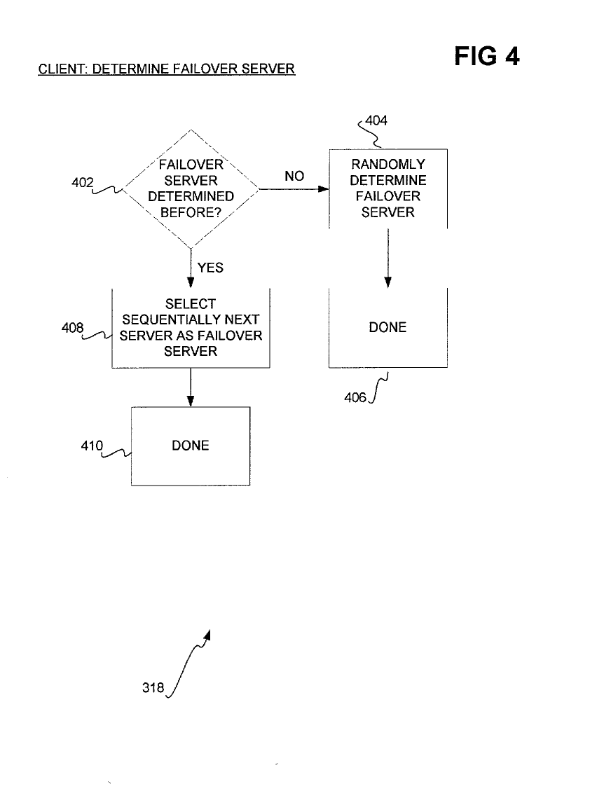

FIGS. 3A, 3B, and 4 are methods showing in more detail the functionality performed by the clients within the client layer 102 of FIGS. 1 and 2. Referring first to FIGS. 3A and 3B, a method 300 is shown that is performed by a client when it wishes to send a request for data to a data server. The client first determines the proper server to which to direct the request (302). Because the data is partitioned for processing purposes over the data servers, only one of the servers is responsible for each unique piece of data. The client then determines whether it has previously entered failover mode as to this server (304). If not, the client sends the request for data to this server (306), and determines whether the request was successfully received by the server (308). If successful, the method 300 ends (310), such that the client ultimately receives the data it has requested.

If unsuccessful, then the client determines whether it has attempted to send the request to this server for more than a threshold number of attempts (312). If it has not, then the client resends the request to the server (306), and determines again whether submission was successful (308). Once the client has attempted to send the request to the server unsuccessfully for more than the threshold number of attempts, it enters failover mode as to this server (314).

In failover mode, the client contacts the master server (316) to notify the master server that the server may be offline. The client then determines a failover server to which to send the request (318). The failover server is a server that the client will temporarily send requests for data that should be sent to the server, but with which the client cannot successfully communicate. Each client may have a different failover server for each data server, and, moreover, the failover server for each data server may change each time a client enters the failover mode for that data server. Once the client has selected the failover server, it sends its request for data to the failover server (320). The method 300 is then finished (322), such that the client ultimately receives the data it has requested, from either the failover server or the server that is normally responsible for the type of data requested.

If the client determines that it had previously entered failover mode as to a data server (304), then the client determines whether it has been in failover mode as to the data server for longer than a threshold length of time (324). If not, then the client sends its request for data to the failover server previously determined (320), and the method 300 is finished (322), such that the client ultimately receives the data it has requested, from either the failover server or the data server that is normally responsible for the type of data requested.

If the client has been in failover mode as to the data server for longer than the threshold length of time, it sends the request to the server (326), to determine whether the server is back online. The client determines whether sending the request was successful (328). If not, the client stays in failover mode as to this data server (330), and sends the request to the failover server (320), such that the method 300 is finished (322). Otherwise, sending the request was successful, and the client exits failover mode as to the data server (332). The client notifies the master server that the data server is back online (334), and the method 330 is finished (336), such that the client ultimately receives the data it has requested from the data that is responsible for this type of data.

FIG. 4 shows a method that a client can perform in 318 of FIG. 3B to select a failover server for a server with which it cannot communicate. The client first determines whether it has previously selected a failover server for this server (402).

If not, then the client randomly selects a failover server from the failover group of servers for this server (404). The failover group of servers may include all the other data servers within the server layer 104, or it may include only a subset of all the other data servers within the server layer 104. The method is then finished (406).

If the client has previously selected a failover server for this server, then it selects as the new failover server the next data server within the failover group for the server (408). This may be for load balancing or other reasons. For example, there may be three servers within the failover group for the server. If the client had previously selected the second server, it would now select the third server. Likewise, if the client had previously selected the first server, it would now select the second server. If the client had previously selected the third server, it would now select the first server. The method is then finished (410).

### Data Server Perspective

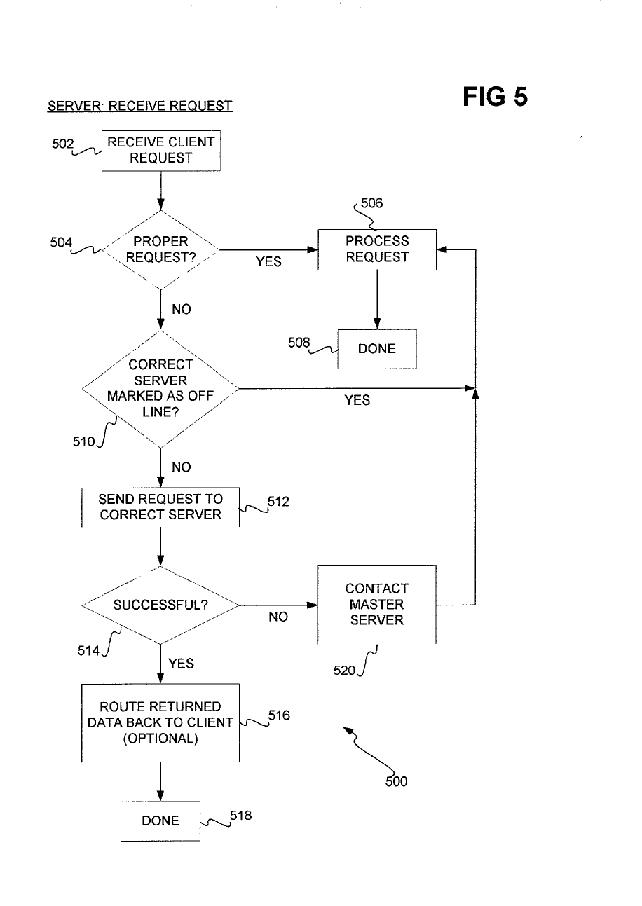

FIGS. 5, 6, and 7 are methods showing in more detail the functionality performed by the data servers within the server layer 104 of FIGS. 1 and 2. Referring first to FIG. 5, a method 500 is shown that is performed by a data server when it receives a client request for data. The server first receives the client request (502). It determines whether the request is a proper request (504). That is, the data server determines if the client request relates to data that has been partitioned to the data server, such that the data server is responsible for processing client requests for such data. If the client request is proper, then the data server processes the request (506), such that the requested data is returned to the requestor client, and the method is finished (508).

If the client request is improper, this means that the data server has received a request for data for which it is not normally responsible. The data server infers that it has received the request from the requestor client because the requestor client was unable to communicate with the proper target server for this data. The proper target server for this data is the server to which the requested data has been partitioned. The requestor client may have been unable to communicate with the proper target server because it is offline, as a result of the connection between the client and the proper target server having failed, or the proper target server itself having failed.

Therefore, the data server determines whether the proper, or correct, server has previously been marked as offline in response to a notification from the master server (510). If so, then the server processes the request (506), such that the requested data is returned to the requester client, and the method is finished (508). If the proper server has not been previously marked as offline, the data server relays the client request for data to the proper server (512), and determines whether submission to the proper server is successful (514). The data server may be able to successfully send the client request to the proper server where the requestor client was unsuccessfully able to do so where the connection between the client and the proper server has failed, but where the proper server itself has not failed. The data server may be unable to successfully send the client request to the proper server where the requestor client was also unsuccessfully able to do so where the proper server itself has failed.

If the data server is able to successfully send the client request to the proper server, then it preferably it receives the data back from the proper server to route back to the requestor client (516). Alternatively, the proper server may itself send the requested data back to the requestor client. In any case, the method is finished (518), and the client has received its requested data. If the data server is unable to successfully send the client request to the proper server, it optionally contacts the master server, notifying the master server that the proper server may be offline (520). The data server then processes the request (506), and the method 500 is finished (508), such that the client has received the requested data.

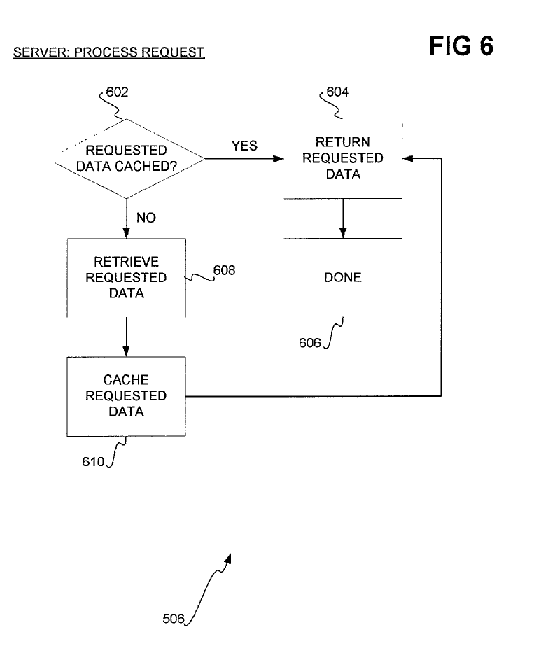

FIG. 6 shows a method that a data server can perform in 506 of FIG. 5 to process a client request for data. The method of FIG. 6 assumes that the database layer 106 is present, such that the data server caches the data partitioned to it, and temporarily caches data for which it is acting as the failover server for a client. First, the data server determines whether the requested data has been cached (602). If so, then the server returns the requested data to the requester client (604), and the method is finished (606). Otherwise, the server retrieves the requested data from the database layer 106 (608), caches the data (610), and then returns the requested data to the requestor client (604), such that the method is finished (606).

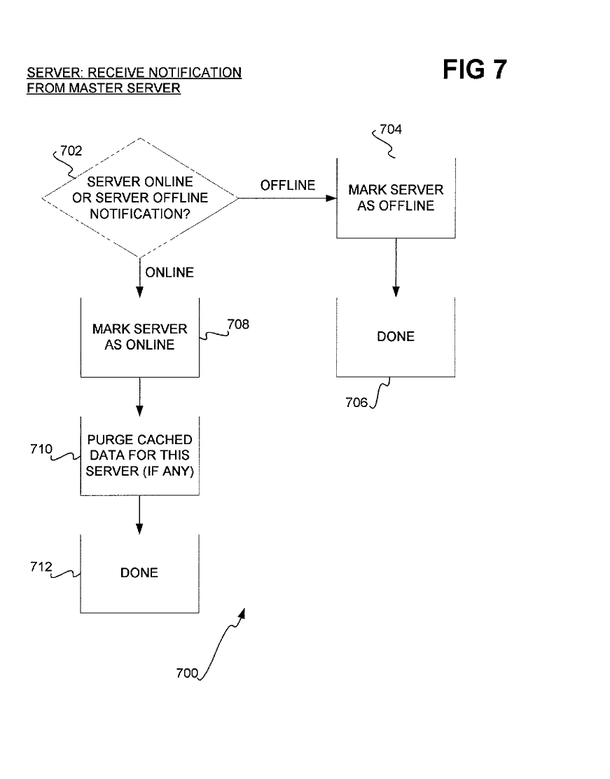

FIG. 7 shows a method 700 that a data server performs when it receives a notification from the master server. First, the data server determines whether the notification is with respect to another server being offline or online (702). If the notification is an offline notification, it marks the indicated server as offline (704), and the method 700 is finished (706). If the notification is an online notification, the data server marks the indicated server as back online (708). The data server also preferably purges any data that it has cached for this indicated server, where the data server acted as a failover server for one or more clients as to this indicated server (710). The method 700 is then finished (712).

### Master Server Perspective

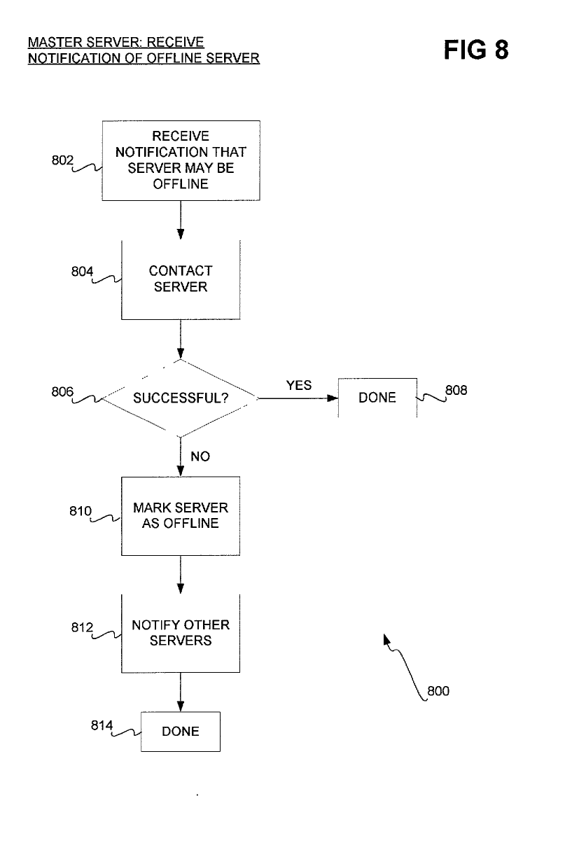

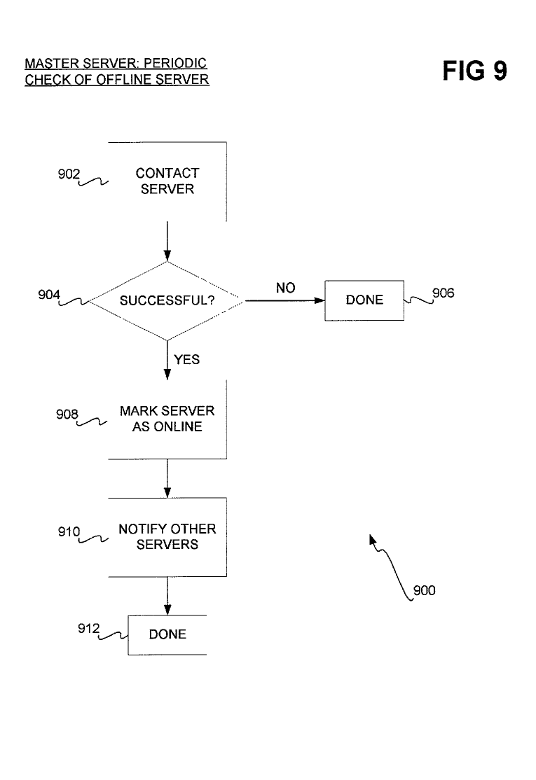

FIGS. 8 and 9 are methods showing in more detail the functionality performed by the master server 104a within the server layer 104 of FIGS. 1 and 2. Referring first to FIG. 8, a method 800 is shown that is performed by the master server 104a when it receives a notification from a client or a data server that an indicated data server may be offline. The master server first receives a notification that an indicated data server may be offline (802). The master server next attempts to contact this data server (804), and determines whether contact was successful (806). If contact was successful, the master server concludes that the indicated server has in fact not failed, and the method is finished (808).

It is noted that a server may still be considered offline from the perspective of a client, even though it has not failed. This may result from the connection between the client and the server having itself failed. As a result, the client enters failover mode as to this data server, but the master server does not notify the other data servers that the server is offline. This is because the other data servers, and potentially the other clients, are likely still able to communicate with the server with which the client cannot communicate. One of the other data servers still acts as a failover server for the client as to this data server. However, as has been described, the failover server forwards the client's requests that are properly handled by the data server to the data server, for processing by the data server.

That is, the failover server in this situation does not itself process the client's requests that are properly handled by the data server.

Where the master server's attempted contact with the indicated data server is unsuccessful, the master server marks the server as offline (810). The master server also notifies the other data servers that the indicated data server is offline (812). This enables the other data servers to also mark the indicated data server as offline. The method 800 is then finished (814).

FIG. 9 shows a method 900 that the master server 104a periodically performs to determine whether an offline data server is back online. The master server contacts the data server (902), and determines whether it was successful in doing so (904). If unsuccessful, the method 900 is finished (906), such that the data server retains its marking with the master server as being offline. If successful, however, the master server marks the data server as online (908). The master server also notifies the other data servers that this data server is back online (910), so that the other data servers can also mark this server as back online. The method 900 is then finished (912).

### Examples of Operation

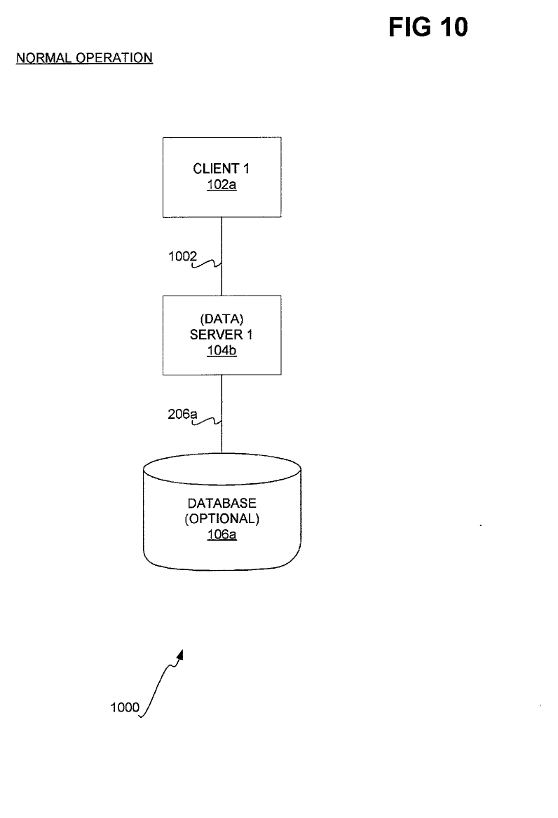

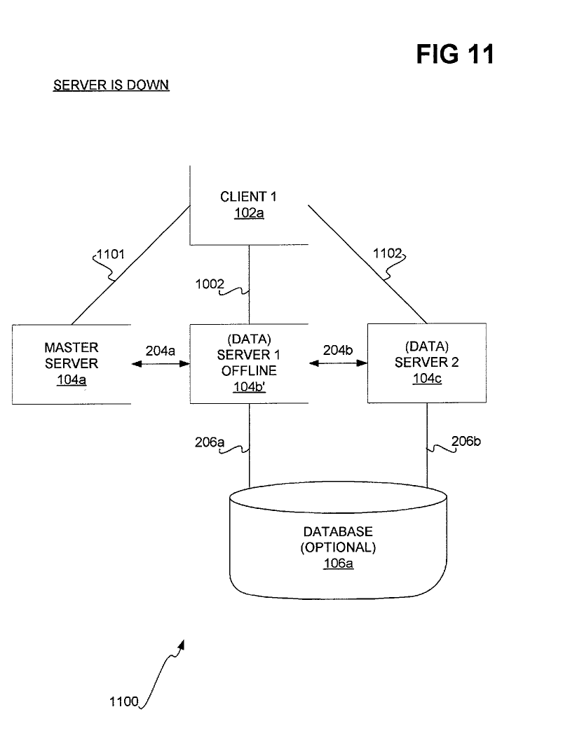

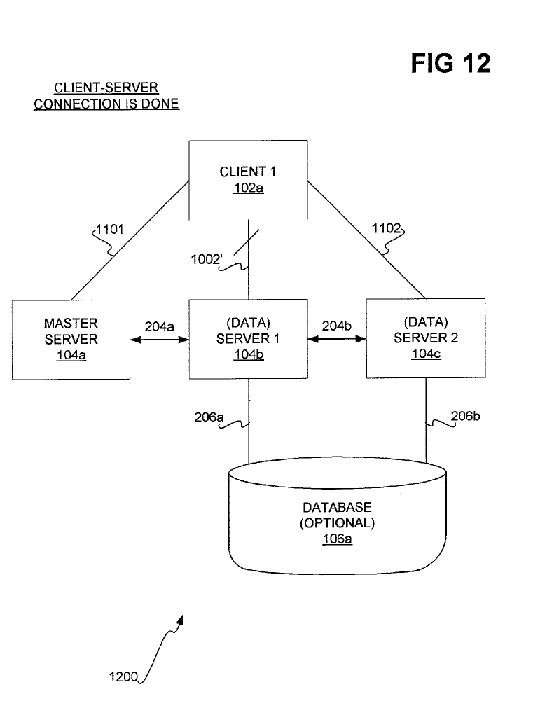

FIGS. 10, 11, and 12 show example operations of the topology 100 of FIGS. 1 and 2. Specifically, FIG. 10 shows normal operation of the topology 100, where no data server is offline. FIG. 11 shows operation of the topology 100 where a data server is offline due to failure, such that none of the clients nor none of the other servers can communicate with the offline server. FIG. 12 shows operation of the topology 100 where a data server is offline due to a failed connection between the server and a client. While the other servers can still communicate with the server, the client(s) cannot, and therefore from that client's perspective, the server is offline.

Referring specifically to FIG. 10, a system 1000 is shown in which there is normal operation between the client 102a, the data server 104b, and the optional database 106a. The client 102a requests data of a type for which the data server 104b is responsible, where there is a connection 1002 between the client 102a and the server 104b. The data server 104b has not failed, nor has the connection 1002. Therefore, the server 104b processes the request, and returns the requested data back to the client 102a. If the server 104b has the data already cached, then it does not need to query the database 106a for the data. However, if the server 104b does not have the requested data cached, then it first queries the database 106a for the data and caches the data when received from the database 106a before it returns the data to the client 102a. The server 104b is connected to the database 106a by the connection 206a.

Referring next to FIG. 11, a system 1100 is shown in which the data server 104b has failed, such that it is indicated as the data server 104b′. The client 102a requests data of a type for which the data server 104b′ is responsible, where there is the connection 1002 between the client 102a and the server 104b′. However, because the data server 104b′ has failed, and is offline to the client 102a, the client 102a selects the data server 104c as its failover server for the server 104b′. The client 102a notifies the master server 104a through the connection 1101 that it cannot communicate with the server 104b′. The master server 104a also attempts to contact the server 104b′, through the connection 204a. It is also unable to do so, because the server 104b′ has failed. Therefore, the master server 104a contacts the other servers, including the server 104c through the connections 204a and 204b, to notify them that the server 104b′ is offline. The other servers, including the server 104c, marks the server 104b′ as offline in response to this notification. It is noted that the master server 104a has a connection directly to each of the data servers 104b′ and 104c, which is not expressly indicated in FIG. 11.

The client 102a sends its client requests during failover mode that should normally be sent to server 104b′ instead to server 104c, since the latter is acting as the failover server for the client 102a as to the former. The client 102a is connected to the server 104c through the connection 1102. When the server 104c receives the request, it determines that the request is not for data of the type for which the server 104c is normally responsible, and determines that the server that is normally responsible for handling such requests, the server 104b′, has been marked offline. Therefore, the server 104c handles the request. If the request is for data that has been cached by the server 104c, then the data is returned to the client 102a. Otherwise, the server 104c queries the database 106a through the connection 206b, receives the data from the database 106a, caches the data, and returns it to the client 102a.

Referring finally to FIG. 12, a system 1200 is shown in which the connection 1002 between the client 102a and the server 104b has failed, even though the server 104 is online. This failed connection is indicated as the connection 1002′. The client 102a requests data of a type for which the data server 104b is responsible. However, because the connection 1002′ has failed, such that the data server 104b is offline from the perspective of the client 102a, the client 102a selects the data server 104c as its failover server for the server 104b. The client 102a notifies the master server 104a through the connection 1101 that it cannot communicate with the server 104b. The master server 104a also attempts to contact the server 104b, through the connection 204a. However, it is able to contact the server 104b. Therefore, it does not notify the other servers regarding the server 104b.

The client 102a sends its client requests during failover mode that should normally be sent to server 104b instead to server 104c, since the latter is acting as the failover server for the client 102a as to the former. The client 102a is connected to the server 104c through the connection 1102. When the server 104c receives the request, it determines that the request is not for data of the type for which the server 104c is normally responsible. The server 104c also determines that the server that is normally responsible for handling such requests, the server 104b, has not been marked offline. Therefore, the server 104c passes the request to the server 104b. The server 104b, because it has not in fact failed, handles the request. The server 104b passes it back to the server 104c to return to the client 102a. If the request is for data that has not yet been cached by the server 104b, then the server 104b must first query the database 106a through the connection 206a to receive the data.

### Example Server or Client

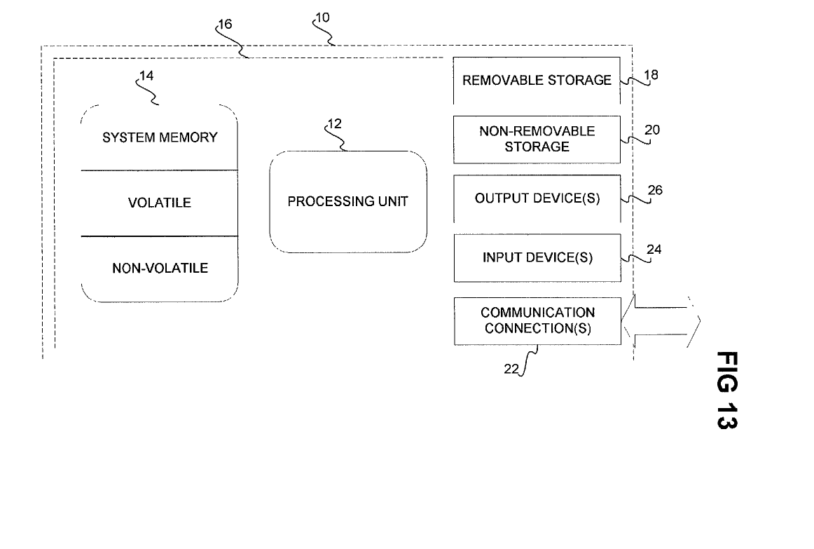

FIG. 13 illustrates an example of a suitable computing system environment 10 on which the invention may be implemented. For example, the environment 10 can be a client, a data server, and/or a master server that has been described. The computing system environment 10 is only one example of a suitable computing environment and is not intended to suggest any limitation as to the scope of use or functionality of the invention. Neither should the computing environment 10 be interpreted as having any dependency or requirement relating to any one or combination of components illustrated in the exemplary operating environment 10. In particular, the environment 10 is an example of a computerized device that can implement the servers, clients, or other nodes that have been described.

The invention is operational with numerous other general purpose or special purpose computing system environments or configurations. Examples of well known computing systems, environments, and/or configurations that may be suitable for use with the invention include, but are not limited to, personal computers, server computers, handor laptop devices, multiprocessor systems, microprocessorsystems. Additional examples include set top boxes, programmable consumer electronics, network PCs, minicomputers, mainframe computers, distributed computing environments that include any of the above systems or devices, and the like.

The invention may be described in the general context of computerinstructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An exemplary system for implementing the invention includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated by dashed line 16. Additionally, device 10 may also have additional features/functionality. For example, device 10 may also include additional storage (removable and/or non-removable) including, but not limited to, magnetic or optical disks or tape. Such additional storage is illustrated in by removable storage 18 and non-removable storage 20.

Computer storage media includes volatile, nonvolatile, removable, and non-removable media implemented in any method or technology for storage of information such as computer readable instructions, data structures, program modules, or other data. Memory 14, removable storage 18, and non-removable storage 20 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Communications connection(s) 22 is an example of communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 10 may also have input device(s) 24 such as keyboard, mouse, pen, voice input device, touch input device, etc. Output device(s) 26 such as a display, speakers, printer, etc. may also be included. All these devices are well know in the art and need not be discussed at length here.

The methods that have been described can be computer-implemented on the device 10. A computer-implemented method is desirably realized at least in part as one or more programs running on a computer. The programs can be executed from a computer-readable medium such as a memory by a processor of a computer. The programs are desirably storable on a machine-readable medium, such as a floppy disk or a CD-ROM, for distribution and installation and execution on another computer. The program or programs can be a part of a computer system, a computer, or a computerized device.

### Conclusion

It is noted that, although specific embodiments have been illustrated and described herein, it will be appreciated by those of ordinary skill in the art that any arrangement or method that is calculated to achieve the same purpose may be substituted for the specific embodiments shown. This application is intended to cover any adaptations or variations of the present invention. Therefore, it is manifestly intended that this invention be limited only by the claims and equivalents thereof.

1. A system comprising:
a plurality of servers organized into one or more failover groups and over which data is partitioned, each server usually processing client requests for data of a respective type and processing the client requests for data other than the respective type for other of the plurality of servers within a same failover group when the other of the plurality of servers within the same failover group are offline; and,
a master server managing notifications from one or more clients and from the plurality of servers as to whether servers are offline, the master server verifying whether a server is offline when so notified, and where the server has been verified as offline, so notifying the plurality of servers other than the server that has been verified as offline.

2. The system of claim 1, further comprising a database storing data responsive to client requests of any respective type and which has been partitioned over the plurality of servers, each server caching the data stored in the database responsive to client requests of the respective type.

3. The system of claim 2, wherein each server further temporarily caches the data stored in the database responsive to client requests other than the respective type when the other of the plurality of servers within the same failover group are offline.

4. The system of claim 1, wherein the one or more failover groups consists of one failover group, such that the plurality of servers are within the one failover group.

5. The system of claim 1, further comprising one or more clients sending requests to the plurality of servers.

6. A system comprising:
a plurality of servers organized into one or more failover groups, each server usually processing client requests of a respective type and processing the client requests other than the respective type for other of the plurality of servers within a same failover group when the other of the plurality of servers within the same failover group are offline; and,
a database storing data responsive to client requests of any respective type and which is partitioned for caching over the plurality of servers, each server caching the data stored in the database responsive to client requests of the respective type, each server also temporarily caching the data stored in the database responsive to client requests other than the respective type when the other of the plurality of servers within the same failover group are offline.

7. The system of claim 6, further comprising a master server managing notifications from one or more clients and from the plurality of servers as to whether servers are offline, the master server verifying whether a server is offline when so notified, and where the server has been verified as offline, so notifying the plurality of servers other than the server that has been verified as offline.

8. The system of claim 6, wherein the one or more failover groups consists of one failover group, such that the plurality of servers are within the one failover group.

9. The system of claim 6, further comprising one or more clients sending requests to the plurality of servers.

10. A computer-readable medium having instructions stored thereon for execution by a processor to perform a method comprising:
determining whether a data server is in a failover mode;
in response to determining that the data server is not in the failover mode,
sending a request to the data server;
determining whether sending the request was successful;
in response to determining that sending the request was unsuccessful,
entering the failover mode for the data server;
notifying a master server that sending the request to the one of the plurality of data servers was unsuccessful;
determining a failover server; and,
sending the request to the failover server.

11. The medium of claim 10, the method initially comprising determining the data server as one of a plurality of data servers to which to send the request.

12. The medium of claim 10, the method initially comprising in response to determining that sending the request was unsuccessful, repeating sending the request to the data server for a predetermined number of times, and entering the failover mode for the data server if sending the request for the predetermined number of times was still unsuccessful.

13. The medium of claim 10, the method further comprising in response to determining that the data server is in the failover mode,
determining whether the data server has been in the failover mode for longer than a predetermined length of time; and,
in response to determining that the data server has not been in the failover mode for longer than the predetermined length of time, sending the request to the failover server.

14. The medium of claim 13, the method further comprising in response to determining that the data server has been in the failover mode for longer than the predetermined length of time,
sending the request to the one of the plurality of data servers;
determining whether sending the request was successful;
in response to determining that sending the request was unsuccessful, sending the request to the failover server;
in response to determining that sending the request was successful,
exiting the failover mode for the data server; and,
notifying the master server that sending the request to the data server was successful.

15. A method for performance by a server comprising:
receiving a request from a client;
determining whether the request is of a type usually processed by the server;
in response to determining that the request is of the type usually processed by the server, processing the request;
in response to determining that the request is not of the type usually processed by the server,
determining whether a second server that usually processes the type of the request is indicated as offline;
in response to determining that the second server that usually processes the type of the request is indicated as offline, processing the request;
in response to determining that the second server that usually processes the type of the request is not indicated as offline,
sending the request to the second server;
in response to determining that sending the request was unsuccessful,
processing the request; and,
notifying a master server that the second server is offline.

16. The method of claim 15, further comprising receiving indication from a master server that the second server is online.

17. The method of claim 15, further comprising receiving indication from a master server that the second server is offline.

18. A computer-readable medium having instructions stored thereon for performing the method of claim 15.

19. A machine-readable medium having instructions stored thereon for execution by a processor of a master server to perform a method comprising:
receiving a notification that a server may be offline;
contacting the server;
determining whether contacting the server was successful;
in response to determining that contacting the server was unsuccessful,
marking the server as offline; and,
notifying a plurality of servers other than the server marked as offline that the server is offline.

20. The medium of claim 19, the method further comprising periodically checking the server that has been marked as offline to determine whether the server is back online.

21. The medium of claim 20, wherein periodically checking the server that has been marked as offline comprising:
contacting the server;
determining whether contacting the server was successful;
in response to determining that contacting the server was successful,
marking the server as online; and,
notifying the plurality of servers other than the server marked as online that the server is online.
